(19) United States
(12) Patent Application Publication
(10) Pub. No.: US 2008/0193625 A1
(43) Pub. Date: Aug. 14, 2008

(54) Method of Processing Oligosaccharide-Rich Coffee Beans

(76) Inventors: Mineko Kawamura, Osaka (JP); Koichi Nakahara, Osaka (JP)

Correspondence Address: DRINKER BIDDLE & REATH (DC), 1500 K STREET, N.W., SUITE 1100, WASHINGTON, DC, 20005-1209, US

(21) Appl. No.: 11/883,156

(22) PCT Filed: Jan. 25, 2006
(86) PCT No.: PCT/JP2006/301111

§ 371 Date: Jan. 14, 2008

(30) Foreign Application Priority Data
Jan. 28, 2005 (JP) 2005-022199

(51) Int. Cl. A23F 5/10

(52) U.S. Cl. 426/595; 426/629; 426/433

(57) ABSTRACT

A method of processing coffee beans, wherein a step for bringing roasted coffee beans into contact with a high-temperature, high-pressure fluid increases an amount of oligosaccharides in the roasted coffee beans.

### TECHNICAL FIELD

The present invention relates to a method of processing coffee beans.

### BACKGROUND ART

Coffee beverages packed in cans or PET-bottles can be easily consumed anywhere, and have come into wide acceptance in recent years. As coffee beverages are sold in a larger number of regions, the period for which these beverages are retained on the market (the circulation period) lengthens. Meanwhile, consumers are increasingly demanding coffee beverages having a flavor closer to freshly made coffee.

Maintaining the long-term stability of the favorable flavors characteristic of coffee in coffee beverages packed in cans or PET bottles has therefore been a significant problem in responding to consumer demand.

In particular, the oil components extracted from coffee beans may separate, aggregate over time, and float to the surface in black coffee that does not contain milk components. The flavor components that are characteristic of coffee contain large amounts of these oils, and therefore the deterioration of not only the oil components but also the flavor components is readily promoted by contact with air.

As a result, not only do the degraded oil components appear as floating foreign substances, but the characteristic coffee flavor is also lost. The difference not only from the external appearance but also from the flavor of freshly made coffee therefore increases, and the value of the product may decline precipitously.

Conventionally, in order to prevent the separation and aggregation of oil components, which is one of the causes of diminished product value, homogenizers (homogenizing machines) are used on the coffee extracts, the average particle diameter of the oil components is reduced, and the oil components are uniformly dispersed within the extract (see Patent Document 1).

Alternatively, investigations have been performed for adding locust bean gum, xanthan gum, or other polysaccharide thickeners (foreign stabilizers) to the coffee extract and preventing the separation and aggregation of oil components (see Patent Document 2).

[Patent Document 1] Japanese Patent No. 3130321

[Patent Document 2] Japanese Patent Application Laid-open No. 2001-120184

### DISCLOSURE OF THE INVENTION

Problems that the Invention is Intended to Solve

Processing a coffee extract using a homogenizing machine in order to prevent the separation and aggregation of oil components is labor-intensive and increases equipment costs and running costs for introducing the use of the homogenizing machine. Adding stabilizers to the coffee extract may, depending on the amount of stabilizer, impact the characteristic coffee flavor and increase raw material costs.

Polysaccharides and fiber materials (insoluble components) are present in coffee beans. These insoluble components may impede the extraction of the favorable flavor components that are characteristic of coffee. These insoluble components need to be solubilized and made more readily extractable using a simple operation in order to maintain a flavor in the coffee extract that is as close as possible to freshly made coffee.

The present invention was devised in light of these problems and provides a method of processing coffee beans in which a simple operation is used to extract a coffee extract containing larger amounts of flavor components and in which the separation and aggregation of coffee oil components can be prevented over long periods of time.

### Means for Solving the Problems

As a result of dedicated research into methods of processing coffee beans in which the separation and aggregation of coffee oil components is prevented over long periods of time, the present inventors discovered that the insoluble components in roasted coffee beans are solubilized and the oligosaccharide content is increased by heating roasted coffee beans under certain conditions. New knowledge about the coffee oil components contained in roasted coffee beans was also obtained in regard to the amount of oil components transferred to the coffee extract and the stability of oil components in coffee extract.

A first characteristic configuration of the present invention is a method of processing coffee beans, wherein a step for bringing roasted coffee beans into contact with a high-temperature, high-pressure fluid increases an amount of oligosaccharides in the roasted coffee beans.

A second characteristic configuration of the present invention is a method of processing coffee beans, wherein a step for bringing roasted coffee beans into contact with a high-temperature, high-pressure fluid increases an amount of a coffee oil component transferred to a coffee extract, the coffee oil component being contained in the roasted coffee beans.

A third characteristic configuration of the present invention is a method of processing coffee beans, wherein a step for bringing roasted coffee beans into contact with a high-temperature, high-pressure fluid stabilizes a coffee oil component in a coffee extract, the coffee oil component being contained in the roasted coffee beans.

A step is performed for bringing roasting coffee beans or roasted coffee beans into contact with a high-temperature, high-pressure fluid (referred to hereinafter as the “high-temperature, high-pressure process”). Polysaccharides and fiber materials, which are insoluble components present in the roasted coffee beans, are thereby hydrolyzed, and the content of oligosaccharides, which are soluble components, is increased. In other words, the oligosaccharide content of the coffee beans is increased relative to the oligosaccharide content of green coffee beans.

The oligosaccharides assume the role of surfactants if normal grinding and extraction is performed on roasted coffee beans subjected to the high-temperature, high-pressure process, and micelles will be formed between the oligosaccharides and the coffee oil components, whereby the oil components are thought to be solubilized and made more readily transferable to the extract.

Most of the coffee oil components, which make up a large part of coffee flavor components, are usually left behind in the extract reside or in the extract vessel when extraction is performed on roasted coffee beans, and few oil components are transferred to the coffee extract. However, according to the present invention, a larger amount of oil components can be extracted, and therefore a coffee extract having a rich flavor can be obtained.

Since the oil components are solubilized in the extract, the stability of the oil components in the coffee extract can be improved without any particular homogenizing machines, foreign stabilizers, or the like being used. As a result, separation and aggregation of the oil components do not occur even when the coffee extract is stored for long periods of time, and the stability of the favorable flavors that are characteristic of coffee can be maintained for long periods of time.

The coffee beans themselves are softened by the high-temperature, high-pressure process; fewer physical barriers due to polysaccharides, fiber materials, and other insoluble components in the beans are presented; and a further improvement is realized in terms of the efficiency with which oligosaccharides, coffee oil components, and various coffee flavor components generated by roasting are extracted.

In a fourth characteristic configuration of the present invention, the step is performed at 100 to 230° C.

According to the present configuration, the high-temperature, high-pressure processing of the roasted coffee beans can be reliably performed, and the generation of oligosaccharides due to hydrolysis of the polysaccharides, fiber materials, and other compounds in the coffee beans can be promoted.

When the temperature is less than 100° C., a long period of time is required for favorable roasted flavor and for the hydrolysis of polysaccharides and fiber materials, resulting in poor operational efficiency. When the temperature is higher than 230° C., many of the favorable roasted flavors will disperse, and the prevalence of burnt flavors will increase, which is not suitable for beverages.

In a fifth characteristic configuration of the present invention, the step is performed at 160 to 210° C.

According to the present configuration, the generation of oligosaccharides can be promoted and the extraction amount of coffee oils can be increased in the range of 160° C. to 210° C., especially.

In a sixth characteristic configuration of the present invention, the step is performed at a gauge pressure of 0.1 to 3.0 MPa.

According to the present configuration, the high-temperature, high-pressure processing of the roasted coffee beans can be reliably performed, and the generation of oligosaccharides due to hydrolysis of the polysaccharides, fiber materials, and other compounds in the coffee beans can be promoted.

When the gauge pressure is less than 0.1 MPa, the reactions will require long periods of time, which is not suitable for the operation from the standpoint of operational efficiency. When the pressure is higher than 3.0 MPa, the pressure within the reaction vessel will be difficult to control. Such pressure levels are therefore not suitable for the operation from the standpoint of handling.

The generation of oligosaccharides can be promoted and the extraction amount of oil components can be increased in the range of gauge pressures from 0.1 MPa to 3.0 MPa.

In a seventh characteristic configuration of the present invention, the fluid is a saturated steam.

According to the present configuration, the thermal conduction efficiency increases significantly (by a factor of approximately 10) over dry air (hot-air roasting). As a result, the roasting time can be shortened to approximately 30 seconds to 4 minutes using the present configuration, where the necessary processing time using hot-air roasting is usually 15 minutes to 30 minutes or more; however, this will depend on the desired degree of roasting (from light roasting to Italian roasting). The generation of oligosaccharides due to hydrolysis of polysaccharides, fiber materials, and other compounds in the roasted coffee beans is also further promoted by the excellent heat-conducting ability of saturated steam.

An eighth characteristic configuration of the present invention is a processed coffee bean product that is processed using the method of processing coffee beans according to any one of the first through seventh characteristic configurations.

According to the present configuration, roasted coffee beans can be provided in which the oligosaccharide content is increased and the extraction efficiency of coffee flavor components can be improved.

A ninth characteristic configuration of the present invention is a coffee beverage wherein the processed coffee bean product according to the eighth characteristic configuration is used as a raw material.

According to the present configuration, a coffee beverage in which the coffee oils will not separate and aggregate even during long storage can be provided having a rich flavor that can be stably maintained for long periods of time.

A tenth characteristic configuration of the present invention is a processed coffee bean product having a degree of roasting of L15 to L23 and a soluble oligosaccharide content of 40 mg to 65 mg per gram, the oligosaccharides having a molecular weight of 500 to 3000.

According to the present configuration, an abundance of soluble oligosaccharides can be included after roasting of the degree used for coffee beverages. The present configuration can therefore ideally be used as a raw material for coffee beverages.

### BEST MODE FOR CARRYING OUT THE INVENTION

Embodiments of the present invention will be described below.

The method of processing coffee beans of the present invention involves bringing coffee beans into contact with a high-temperature, high-pressure fluid and will be referred to below as the “high-temperature, high-pressure process.”

Green coffee beans in the process of being roasted, roasted coffee beans, or other coffee beans may be used as the raw material of the high-temperature, high-pressure process.

Examples of the variety of coffee may include arabica, robusta, and liberica.

Examples of roasted coffee beans may include beans of a high or low degree of roasting, and roasted beans that have been subjected to high-pressure or other processes. Roasting by direct firing, hot air, far-infrared rays, microwaves, or other methods may be used as the roasting method.

“Green coffee beans” refers to dried seeds that have been purified after the pulp, skin, and other parts from harvested coffee cherries, which are the fruits of coffee trees, have been removed. The purifying step may involve washing with water, washing without water, or other processes.

The particle size of the coffee beans will limit the extraction of components from the high-temperature, high-pressure process, and therefore whole grain or a low degree of grinding is preferable, but these cases are not given by way of limitation. A ground product (very coarsely ground beans or the like) in a range within which the components can be extracted may also be used.

In order to increase the oligosaccharides contained in roasted coffee beans, the high-temperature, high-pressure process of the present invention is performed on normal roasted coffee beans obtained using well-known methods. The high-temperature, high-pressure process of the present invention also has a roasting effect simultaneous with the oligosaccharide increase, and the high-temperature, high-pressure process can therefore also be used as part of a roasting process.

“Oligosaccharides” in the present specification refers to polymers of approximately 2 to 200 monosaccharides polymerized by glycosidic bonds.

The amount of the coffee oil components transferred from the roasted coffee beans to the coffee extract is increased by the high-temperature, high-pressure process of the present invention. The “coffee oil components” in the present invention are lipids contained in coffee beans, and the primary components of these lipids are triglycerides (compounds in which three fatty acids are ester-linked to the hydroxyls of glycerol). These oil components have hydrophobic groups and therefore envelope flavor components. These oils are generally known for having the effect of maintaining the stability of these flavor components.

Examples of liquids that may be used as the fluid employed in the high-temperature, high-pressure process include distilled water, desalinated water, tap water, alkali ion water, deep-sea water, ion-exchange water, deoxygenated water, or water containing water-soluble organic compounds (e.g., alcohol) or inorganic salts, but these examples are not given by way of limitation.

Examples of gases that may be used as the fluid employed in the high-temperature, high-pressure process include vapors of the aforementioned liquids, such as water and alcohol vapor. From the standpoint of workability and handleability, the steam is preferably saturated steam, but this case is not given by way of limitation.

Other than the fluids above, examples of the fluid employed in the high-temperature, high-pressure process include supercritical fluids or subcritical fluids. Once a specific temperature and pressure (critical point) are exceeded, the boundary between gas and liquid will dissipate, leaving a region where the fluid is sustained in a state in which both phases are blended together. Such a fluid is called a supercritical fluid. Supercritical fluids have high density and have properties somewhere between a gas and a liquid. Subcritical fluids are fluids in a state in which the pressure and temperature are below the critical point.

Examples of the method for supplying the high-temperature, high-pressure fluid include batch systems, in which the fluid is supplied to a pressure vessel, and a set processing time is maintained while the temperature and pressure are increased. Alternatively, in a continuous system, the fluid is made to flow for a set period of time in a pressure vessel from a fluid-supply pathway to a fluid-discharge pathway provided to the pressure vessel so that the fluid will be discharged from the fluid-discharge pathway at an exit pressure that is higher than atmospheric pressure. However, the method is not particularly limited as long as the pressure within the pressure vessel can be sustained.

The direction of flow when the fluid is supplied in a continuous system is not particularly limited. Examples include top to bottom, bottom to top, outside to inside, and inside to outside relative to the green coffee beans to be subjected to the high-temperature, high-pressure process.

The temperature during the high-temperature, high-pressure process is preferably be approximately 100° C. to 230° C. In the present invention, it is necessary to hydrolyze polysaccharides and fiber materials, which are insoluble components of roasted coffee beans, and obtain soluble components; therefore, a relatively higher temperature of approximately 160° C. to 210° C. is particularly preferable.

The high-temperature, high-pressure process is preferably performed under pressurized conditions, and a gauge pressure of 0.1 to 3.0 MPa is particularly preferable. Saturated steam pressure is particularly preferred during high-temperature, high-steam processes. “Pressure” in the present specification refers to the “gauge pressure” with atmospheric pressure as 0. Therefore, the conversion of, e.g., “a gauge pressure of 0.1 MPa” to absolute pressure would yield a pressure of 0.1 MPa plus atmospheric pressure. A gauge pressure of approximately 0.7 to 3.0 MPa is particularly preferable.

The processing time is preferably approximately 1 s to 60 min., and more preferably approximately 30 s to 4 min.

Well-known processes may also be performed after the high-temperature, high-pressure process in the present invention. Examples of well-known processes include grinding, extraction (including supercritical fluid extraction), and drying (vacuum drying and the like), but these cases are not given by way of limitation.

A processed coffee bean product that has been subjected to the high-temperature, high-pressure process in this manner is stored in a silo or the like using standard methods after being cooled and dried (vacuum drying, hot-air drying, or the like).

The resulting processed coffee bean product of the present invention has an abundance of soluble oligosaccharides after roasting to the degree used for coffee beverages. For example, if the degree of roasting is L15 to 23, the soluble oligosaccharide content will be 40 to 65 mg per gram of beans, where the molecular weight of the oligosaccharides is 500 to 3000 (see Example 3, described hereinafter).

A grinding step may also be performed before or during the high-temperature, high-pressure process. Uniform processing is thereby possible, the raw materials in the mixture can be mixed uniformly, and the high-temperature, high-pressure process of the present invention can also be uniformly performed. Molding of the high-temperature, high-pressure processed material of the present invention is also simplified. A mixing step may also be performed in addition to the grinding. The ground raw materials can thereby be uniformly mixed.

An extruder is preferably used in order to efficiently carry out the present invention. Operations after the aforedescribed process can thereby be greatly simplified. The use of an extruder is also suitable for supplying large amounts of processed products due to the fact that continuous processing is possible.

Extruders are often used in the manufacture of puffed foods and the like. An extruder is an apparatus with which raw materials are mixed, heated, pressurized, and extruded from a die in a high-temperature, high-pressure state using one or more screws positioned within an extrusion cylinder.

The twin-screw format is more preferable in the present invention due the fact that the high-temperature, high-pressure process can be stably performed thereby. Using an extruder allows continuous processing to be performed, and, if the pressure of the process atmosphere is suddenly reduced from a high to a low level the water will evaporate after processing.

A processed material that is molded into the desired shape can be obtained by appropriately selecting the shape of the aforedescribed die. Any apparatus other than those described above may also be used as long as the aforedescribed conditions of the present invention can be implemented.

The processed coffee bean product of the present invention is a raw material for coffee beverages and can be used together with roasted coffee beans, instant coffee, liquid coffee extracts, and the like when manufacturing coffee beverages in a factory using standard methods.

Examples of manufacturing steps for canning coffee beverages include “grinding,” “extracting,” “blending,” “filtering,” “filling,” “seaming,” “sterilizing,” “cooling,” and “boxing.” Alternatively, roasted coffee beans may be used, and instant coffee, liquid coffee extracts, or the like may be prepared.

The present invention will be described more specifically below using examples, but the present invention is not limited to these examples.

### EXAMPLE 1

Roasted coffee beans (L=29 (a general indicator called the “L value” displays the chromaticity and brightness of a solid or liquid), arabica) were introduced into a pressure vessel having a fluid-inlet pipe and a fluid-outlet pipe. 1.3-MPa high-pressure (saturated) steam (194° C.) was supplied from the fluid-inlet pipe at a flow volume of 100 kg per kilogram of roasted coffee beans per hour. This ventilation process was performed and processing was carried out at 194° C. for 4 min. at a pressure of 1.3 MPa. A processed coffee bean product (Invention 1) having an L value of 18 was obtained.

Green coffee beans (arabica) were subjected to hot-air roasting using an ordinary electric roaster (hot-air roaster), and roasted coffee beans (Comparison Product 1) having an L value of 18 were obtained.

After being ground in a mill, samples of Invention 1 and Comparison Product 1 were each measured out in an amount of 30 g, and extraction was performed in 450 g of hot water using a general drip-style coffee maker. The extract was subjected to centrifugal separation (7000 g×5 min), any admixed fine powder was removed, and coffee beverages were obtained. The basic components contained in the coffee beverages were evaluated.

The soluble solid content of the coffee beverages was evaluated by taking the difference between the mass of the samples and the water content determined by a drying method employing heating and normal pressure. The oil components were evaluated by a shaking extraction method employing hexane. Soluble sugars were calculated using a formula according to nutritional labeling standards; i.e., (100−(water+protein+oil+ash+dietary fiber)). The values used were evaluated using the kjeldahl method for protein, the direct ashing method for ash, and the enzymatic-gravimetric method for dietary fiber.

TABLE 1

| | | Coffee beverage |
|---|---|---|
| | Coffee beverage | of Comparison |
| Sample | of Invention 1 | Product 1 |
| Amount of coffee beans used (g) | 30 | 30 |
| Amount of hot water used (g) | 450 | 450 |
| Amount of recovered coffee | 396 | 390 |
| beverage (g) | | |
| Solid content of coffee beverage | 1.8 | 1.2 |
| (g/100 g of coffee beverage) | | |
| Coffee oil component content in | 13.9 | 9.8 |
| coffee beverage (mg/100 g of | | |
| coffee beverage) | | |
| Soluble sugar content (including | 0.8 | 0.5 |
| oligosaccharides) in coffee | | |
| beverage (g/100 g of coffee | | |
| beverage) | | |

It was determined that large amounts of coffee oils and soluble sugars were contained in the coffee beverage of Invention 1. The results of separation using HPLC (detector: differential refractive index detector) also indicated that the soluble sugars that increased in the coffee beverage of Invention 1 were oligosaccharides having molecular weights of approximately 500 to 3000.

A calibration curve was created using commercial purified oligosaccharides, whereby the concentrations of oligosaccharides having a molecular weight of approximately 500 to 3000 were evaluated. These oligosaccharides had a characteristic abundance in the coffee beverage of the invention. The results indicated that approximately 2.5 times as many oligosaccharides having a molecular weight of approximately 500 to 3000 were contained in the coffee beverage of the invention as compared to the coffee beverage of the comparison product.

TABLE 2

| | Roasted beans of | Roasted beans of |
|---|---|---|
| Sample | Invention 1 | Comparison Product 1 |
| Oligosaccharides of | 351 | 147 |
| molecular weight 500 to | | |
| 3000 (mg/100 g of | | |
| coffee beverage) | | |

### EXAMPLE 2

150 ppm of coffee oil components obtained by pressing roasted coffee beans was added to Comparison Product 1, and stirring was performed for 15 minutes at 3000 rpm using a mixer, whereby an oil-supplemented coffee beverage (Comparison Product 2) was obtained. Comparison Product 2 and the coffee beverages obtained in Example 1 were evaluated for flavor, condition, and storage stability.

Evaluations of storage stability were performed as follows. (1) An evaluation of the separation and aggregation of the oil components in the samples was performed after the samples had been left in a refrigerator for one week at 4° C., and (2) an evaluation was made of the change in flavor of the samples resulting from forced deterioration after the samples had been stored undisturbed in an incubator for one week at 50° C.

A sensory evaluation was performed by five professional panelists. The flavor of the coffee beverages was evaluated on the basis of richness and strength of aroma. The evaluation was in four grades from strong (3) to none (0). The averages of the five panelists were calculated and designated as “◯” (2.0 or more), “Δ” (1.0 or more to less than 2.0), and “X” (less than 1.0).

An evaluation was also made as to whether or not the flavor had deteriorated in the samples after forced deterioration. The evaluation was in four grades from none (3) to strong (0). The averages of the five panelists were calculated and designated as “◯” (2.0 or more), “Δ” (1.0 or more to less than 2.0), and “X” (less than 1.0).

TABLE 3

| | | | Coffee | Coffee |
|---|---|---|---|---|
| | | Coffee | beverage of | beverage of |
| | | beverage of | Comparison | Comparison |
| Sample | | Invention 1 | Product 1 | Product 2 |
| Flavor | Richness | ◯ | X | ◯ |
| | Aroma | ◯ | X | ◯ |
| Condition | Turbidity | 3.63 | 2.37 | 3.12 |
| | (NTU) | | | |
| | Separation of | None | None | Some |
| | oil | | | |
| | components | | | |
| Storage | Separation | None | Slight | Prevalent |
| stability | and | | | |
| | aggregation | | | |
| | of oil | | | |
| | components | | | |
| | after | | | |
| | refrigeration | | | |
| | storage at | | | |
| | 4° C. | | | |
| | Flavor change | Δ | X | X |
| | after forced | | | |
| | deterioration | | | |
| | at 50° C. | | | |

The results of the evaluations indicate that separation and aggregation of oil components do not occur in the coffee beverage used in the invention even during long-term storage, and that the flavor of the coffee beverage used in the invention is also highly stable after forced deterioration at high temperatures (Table 3).

### EXAMPLE 3

Roasted coffee beans (L=29 (a general indicator called the “L value” displays the chromaticity and brightness of a solid or liquid), arabica) were introduced into a pressure vessel having a fluid-inlet pipe and a fluid-outlet pipe. 1.3-MPa high-pressure (saturated) steam (190° C.) was supplied from the fluid-inlet pipe at a flow volume of 100 kg per kilogram of roasted coffee beans per hour. This ventilation process was performed and processing was carried out at 194° C. for 1 s to 5 min. at a pressure of 1.3 MPa. Processed coffee bean products (Samples 3-1 through 3-8) having L values of 15 to 28 were obtained.

Green coffee beans (arabica) were subjected to hot-air roasting using an ordinary electric roaster (hot-air roaster), sampling was performed over the course of 10 to 20 minutes, and roasted coffee beans (Comparison Products 3-1 through 3-7) having L values of 15 to 29 were obtained.

After being ground in a mill, samples of the Samples and the comparison products were each measured out in an amount of 30 g and placed in lidded glass containers. 450 g of pure water was added, and the lids were attached. The samples were soaked under shaking for 15 minutes in a 90° C. bath, and component extraction was performed. The extract was subjected to centrifugal separation (7000 g×5 min.), fine powder was removed, and coffee extracts were obtained.

In the resulting coffee extracts, the amount of oligosaccharides having molecular weights of 500 to 3000, which were strikingly increased in the inventions, was measured by HPLC (detector: differential refractive index detector).

TABLE 4

| | | Oligosaccharides of |
|---|---|---|
| | | molecular weight 500 |
| | | to 3000 (mg/g of |
| | L value | beans) |
| Sample 3-1 | 28 | 19.5 |
| Sample 3-2 | 27 | 26.1 |
| Sample 3-3 | 26 | 31.1 |
| Sample 3-4 | 23 | 39.7 |
| Sample 3-5 | 22 | 54.2 |
| Sample 3-6 | 20 | 50.7 |
| Sample 3-7 | 18 | 52.6 |
| Sample 3-8 | 15 | 61.2 |
| Comparison | 29 | 23.2 |
| Product 3-1 | | |
| Comparison | 26 | 21.7 |
| Product 3-2 | | |
| Comparison | 22 | 23.1 |
| Product 3-3 | | |
| Comparison | 19 | 22.3 |
| Product 3-4 | | |
| Comparison | 17 | 22.3 |
| Product 3-5 | | |
| Comparison | 18 | 22.3 |
| Product 3-6 | | |
| Comparison | 15 | 24.0 |
| Product 3-7 | | |

The results showed that an increase in oligosaccharides was not apparent in Comparison Product 3 even after roasting had progressed, and the oligosaccharide content per gram of beans was 24 mg or less in all cases.

In comparison, oligosaccharides were contained in the Samples (Samples 3-8 through 3-2) having preferable L values of 15 to 27 at approximately 25 mg to 65 mg per gram of beans, and oligosaccharides were contained in Samples (Samples 3-8 through 3-4) having L values of 15 to 23 at approximately 40 mg to 65 mg per gram of beans. The degree of roasting from L values 15 to 23 is particularly suitable for beverages. A striking increase in oligosaccharides was thereby noticeable (Table 4).

### INDUSTRIAL APPLICABILITY

The present invention can be used as a method of processing coffee beans, particularly roasted coffee beans.

1. A method of processing coffee beans, wherein a step for bringing roasted coffee beans into contact with a high-temperature, high-pressure fluid increases an amount of oligosaccharides in the roasted coffee beans.

2. A method of processing coffee beans, wherein a step for bringing roasted coffee beans into contact with a high-temperature, high-pressure fluid increases an amount of a coffee oil component transferred to a coffee extract, the coffee oil component being contained in the roasted coffee beans.

3. A method of processing coffee beans, wherein a step for bringing roasted coffee beans into contact with a high-temperature, high-pressure fluid stabilizes a coffee oil component in a coffee extract, the coffee oil component being contained in the roasted coffee beans.

4. The method of processing coffee beans according to claim 1, wherein the step is performed at 100 to 230° C.

5. The method of processing coffee beans according to claim 4, wherein the step is performed at 160 to 210° C.

6. The method of processing coffee beans according to claim 1, wherein the step is performed at a gauge pressure of 0.1 to 3.0 MPa.

7. The method of processing coffee beans according to claim 1, wherein the fluid is a saturated steam.

8. A processed coffee bean product that is processed using the method of processing coffee beans according to claim 1.

9. A coffee beverage wherein the processed coffee bean product according to claim 8 is used as a raw material.

10. A processed coffee bean product having a degree of roasting of L15 to L23 and a soluble oligosaccharide content of 40 to 65 mg per gram, the oligosaccharides having a molecular weight of 500 to 3000.

11. The method of processing coffee beans according to claim 2, wherein the step is performed at 100 to 230° C.

12. The method of processing coffee beans according to claim 2, wherein the step is performed at a gauge pressure of 0.1 to 3.0 MPa.

13. The method of processing coffee beans according to claim 2, wherein the fluid is a saturated steam.

14. A processed coffee bean product that is processed using the method of processing coffee beans according to claim 2.

15. A coffee beverage wherein the processed coffee bean product according to claim 14 is used as a raw material.

16. The method of processing coffee beans according to claim 3, wherein the step is performed at 100 to 230° C.

17. The method of processing coffee beans according to claim 3, wherein the step is performed at a gauge pressure of 0.1 to 3.0 MPa.

18. The method of processing coffee beans according to claim 3, wherein the fluid is a saturated steam.

19. A processed coffee bean product that is processed using the method of processing coffee beans according to claim 3.

20. A coffee beverage wherein the processed coffee bean product according to claim 19 is used as a raw material.
